(19) United States
(12) Patent Application Publication
(10) Pub. No.: US 2024/0211756 A1
(43) Pub. Date: Jun. 27, 2024

(54) APPARATUS FOR COMPENSATING FOR TRAINING OPERATION VARIATION OF COMPUTATION-IN-MEMORY BASED ARTIFICIAL NEURAL NETWORK

(71) Applicant: Kwangwoon University Industry-Academic Collaboration Foundation, Seoul (KR)

(72) Inventors: Young Ho GONG, Seoul (KR); Woo Hyuck PARK, Bucheon-si (KR); Ye Bin KWON, Seoul (KR)

(21) Appl. No.: 18/472,145

(22) Filed: Sep. 21, 2023

(30) Foreign Application Priority Data
Dec. 27, 2022 (KR) 10-2022-0186115

(51) Int. Cl. G06N 3/08

(52) U.S. Cl. CPC G06N 3/08

(57) ABSTRACT

According to various exemplary embodiments, A training operation variation compensating apparatus and method of a computation-in-memory based artificial neural network using a non-volatile memory array and a robust memory array which perform an operation for training an artificial neural network using a predetermined initial weight and weight noise supplying unit which performs the training operation using a weight obtained by reflecting a noise to an initial weight by applying a noise to any one of the non-volatile memory array and the robust memory array are applied to overcome a limitation of the fundamental memory device variation in the existing processing-in-memory based artificial neural network training to perform a high performance training and correct an accuracy without intervention of the host processor, thereby increasing the energy efficiency.

### CROSS-REFERENCE TO RELATED APPLICATION

This application claims priority under 35 U.S.C § 119 to Korean Patent Application No. 10-2022-0186115, filed in the Korean Intellectual Property Office on Dec. 27, 2022, the entire contents of which are hereby incorporated by reference.

### BACKGROUND

### Field

The present disclosure relates to an apparatus for compensating a training operation variation of an artificial neural network, and more particularly, to a training operation variation compensating apparatus of a computation-in-memory based artificial neural network.

The present patent application has been filed as research projects as described below.
[1] National Research Development Project supporting the Present Invention
   Project Serial No. 1711194823
   Project No.: RS-2023-00212711
   Department: Ministry of Science and ICT
   Project management (Professional) Institute: National research Foundation of Korea
   Technology Planning & Evaluation Research Project Name: Rising research
   Research Task Name: Hardware-software integration optimization to build personalized on-device recommendation system
   Contribution Ratio: 3/10
   Project Performing Institution: Soongsil Univ. Foundation of University-Industry Cooperation
   Research Period: Mar. 1, 2023 to Feb. 29, 2024
[2] National Research Development Project supporting the Present Invention
   Project Serial No. 1711186025
   Project No.: 2022M3I7A2079155
   Department: Ministry of Science and ICT
   Project management (Professional) Institute: National research Foundation of Korea
   Research Project Name: Original technology development project
   Research Task Name: Development of PIM device, driving circuit, and architecture utilizing various ferroelectric memories
   Contribution Ratio: 3/10
   Project Performing Institution: Hanyang Univ. Industry-University Cooperation Foundation
   Research Period: Jan. 1, 2023 to Dec. 31, 2023
[3] National Research Development Project supporting the Present Invention
   Project Serial No. 1711179305
   Project No.: IITP-2022-RS-2022-00156225
   Department: Ministry of Science and ICT
   Project management (Professional) Institute: Institute of Information & Communications Technology Planning & Evaluation
   Research Project Name: University ICT Research Center Development Support Project
   Research Task Name: Development of neuro chip design technique and neuro computing platform which imitate human neural system
   Contribution Ratio: 4/10
   Project Performing Institution: Kwangwoon University Industry-Academic Collaboration Foundation
   Research Period: Jan. 1, 2023 to Dec. 31, 2023

### Description of the Related Art

The contents described in this section merely provide background information on the present exemplary embodiment but do not constitute the related art.

A Von Neumann architecture which utilizes a memory separated from a processing unit, such as CPU or GPU consumes a lot of energy due to memory access as a memory usage rapidly increases during the training of the artificial neural network.

In the case of high performance/high reliable memory using a plurality of transistors, such as existing SRAM, an operation of the existing in-memory computing device has an excellent performance in maintaining the stored data, but is disadvantageous in terms of power and area.

In order to solve this problem, there is a trend to utilize a next-generation in-memory computing device which uses much fewer transistors and in order to reduce energy consumption due to the memory access, there is a trend to utilize a processing-in-memory (PIM) in which the computation is performed in the memory.

Even though the processing-in-memory is implemented using a technology such as SRAM which is an existing high-performance memory, an PIM architecture which utilizes a next-generation non-volatile memory devices (for example, a phase change memory, a resistive memory, or ferroelectric memory) to maximize the integration based on a smaller number of transistors are in the spotlight.

However, such a next-generation non-volatile memory device is vulnerable to a change in a resistance in accordance with a process variations and there is a problem in that the memory values vary depending on a temperature of an operating environment.

According to the operation of the existing in-memory device, after storing a weight in the in-memory device, the convolution of the artificial neural network is performed by means of input x weight operation in accordance with an input signal. However, in the in-memory computing device, a stored value varies according to a characteristic of the device.

(Patent Document 1) Korean Registered Patent No. 10-1991041 (Jun. 13, 2019)

(Patent Document 2) Korean Registered Patent No. 10-2340091 (Dec. 13, 2021)

In Patent Document 1 (Korean Registered Patent No. 10-1991041), a structure which monitors weight variation according to dynamic/static variation in a host computer and calibrates by the host computer is disclosed.

Patent Document 1 corresponds to an inefficient energy structure because the intervention of the host computer is necessary.

In Patent Document 2 (Korean Registered Patent No. 10-2340091), a technique which compensates for degradation of accuracy generated during quantization is disclosed.

Patent Document 2 corresponds to an apparatus which corrects an error generated during quantization based on comparison of weight values before/after quantization.

Patent Document 2 proposes a correcting apparatus by means of intervention of a host processor, like Patent Document 1.

### SUMMARY

An object to be achieved by the present disclosure is to provide an apparatus and a method for compensating for a training operation variation of a computation-in-memory based artificial neural network which enable a high performance training by overcoming a limitation of a fundamental memory device variation in an existing processing-in-memory based artificial neural network training and correct an accuracy without intervention of the host process, thereby improving an energy efficiency.

Other and further objects of the present disclosure which are not specifically described can be further considered within the scope easily deduced from the following detailed description and the effect.

In order to achieve the above-described objects, according to an aspect of the present disclosure, a training operation variation compensating apparatus of an artificial neural network includes a non-volatile memory array which performs an operation for training the artificial neural network using a predetermined initial weight; a robust memory array which performs an operation for training an artificial neural network which is the same as the non-volatile memory array using the initial weight; a weight noise supplying which applies a noise to any one of the non-volatile memory array or the robust memory array to perform the training operation using a weight obtained by reflecting the noise to the initial weight; an accuracy comparing unit which compares a first accuracy for a value calculated in the non-volatile memory array and a second accuracy for a value calculated in the robust memory array; and a weight calibrator which performs backward propagation based on the comparison result performed in the accuracy comparing unit.

Here, the apparatus further includes a weight copy engine which performs weight copy from a memory array having a higher accuracy to a memory array having a lower accuracy based on the comparison result obtained from the accuracy comparing unit, by the weight copying unit.

The weight noise supplying unit applies a noise to the robust memory array at every predetermined first epoch to perform the training operation using the weight in which the noise is reflected.

Here, when the first accuracy is lower than the second accuracy, the weight copy engine performs the weight copy from the robust memory array to the non-volatile memory array and the weight calibrator performs the backward propagation based on a training operation performed in the robust memory array.

When the first accuracy is equal to or higher than the second accuracy, the weight copy engine does not copy the weight and the weight calibrator does not perform the backward propagation.

The accuracy comparing unit compares the first accuracy and the second accuracy at every predetermined second reference epoch, and when the first accuracy is lower than the second accuracy a predetermined reference epoch, the weight calibrator applies an calibration weight to allow the non-volatile memory array to perform the training operation using the calibration weight.

The non-volatile memory array is based on at least one of a magnetoresistive random access memory (MRAM), a phase change memory, and a ferroelectric random access memory (FeRAM).

The robust memory array is based on a static random access memory (SRAM).

In order to achieve the above-described objects, according to another aspect of the present disclosure, a training operation variation compensating method of an artificial neural network performed in a training operation variation compensating apparatus of an artificial neural network including a non-volatile memory array, a robust memory array, a weight noise supplying unit, an accuracy comparing unit, a weight copy engine, and a weight calibrator includes a step of allowing the non-volatile memory array and the robust memory array to perform an operation for training an artificial neural network using a predetermined initial weight; a step of allowing weight noise supplying to apply a noise to any one of the non-volatile memory array or the robust memory array to perform the training operation using a weight obtained by reflecting the noise to the initial weight; a step of allowing the accuracy comparing unit to compare a first accuracy for a value calculated in the non-volatile memory array and a second accuracy for a value calculated in the robust memory array; and a step of allowing the weight calibrator to perform backward propagation based on a comparison result performed in the accuracy comparing unit.

Here, the method further includes a step of allowing a weight copy engine to perform weight copy from a memory array having a higher accuracy to a memory array having a lower accuracy based on the comparison result obtained from the accuracy comparing unit, by the weight copying unit.

In the step of performing a training operation using a weight obtained by reflecting a noise to the initial weight by applying a nose by the weight noiser, the noise is applied to the robust memory array at every predetermined first reference epoch to perform the training operation using a weight to which the noise is reflected.

Here, when the first accuracy is lower than the second accuracy, if the weight copy engine performs the weight copy, the weight is copied from the robust memory array to the non-volatile memory and when the weight calibrator performs the backward propagation based on the comparison result performed in the accuracy comparing unit, the weight calibrator performs the backward propagation based on a training operation performed in the robust memory array, and When the first accuracy is equal to or higher than the second accuracy, the weight copy engine does not copy the weight and the weight calibrator does not perform the backward propagation.

When the accuracy comparing unit compares the first accuracy and the second accuracy, the first accuracy and the second accuracy are compared at every predetermined second reference epoch and when the weight calibrator performs the backward propagation based on the comparison result performed in the accuracy comparing unit, if the first accuracy is lower than the second accuracy a predetermined reference epoch or more, the weight calibrator applies an calibration weight to allow the non-volatile memory array to perform the training operation using the calibration weight.

When the non-volatile memory array performs the operation for training the artificial neural network using a predetermined initial weight, the non-volatile memory array is based on at least one of a magnetoresistive random access memory (MRAM), a phase change memory, and a ferroelectric random access memory (FeRAM) and when the robust memory array performs an operation for training the artificial neural network like the non-volatile memory array, the robust memory array is based on a static random access memory (SRAM).

In order to achieve the above-described objects, according to another aspect of the present disclosure, a computer program is stored in a computer readable recording medium to allow a computer to execute any one of the training operation variation compensating method of an artificial neural network.

As described above, according to an exemplary embodiment of the present disclosure, an apparatus and a method for compensating for a training operation variation of a computation-in-memory based artificial neural network are applied to enable a high performance training by overcoming a limitation of a fundamental memory device variation in an existing processing-in-memory based artificial neural network training and correct an accuracy without intervention of the host process, thereby improving an energy efficiency.

Even if the effects are not explicitly mentioned here, the effects described in the following specification which are expected by the technical features of the present disclosure and their potential effects are handled as described in the specification of the present disclosure.

### BRIEF DESCRIPTION OF DRAWINGS

FIG. 1 is a view for explaining a configuration of a training operation variation compensating apparatus of an artificial neural network according to an exemplary embodiment of the present disclosure;

FIG. 2 is a view for explaining a configuration of a training operation variation compensating apparatus of an artificial neural network according to another exemplary embodiment of the present disclosure;

FIG. 3 is a view illustrating a computation-in-memory architecture based on a memory device of a training operation variation of an artificial neural network according to an exemplary embodiment of the present disclosure;

FIG. 4 is a view illustrating a process model used in training operation variation compensating apparatus and method of an artificial neural network according to an exemplary embodiment of the present disclosure; and

FIG. 5 is a flowchart for explaining a training operation variation compensating method of an artificial neural network according to an exemplary embodiment of the present disclosure.

### DETAILED DESCRIPTION OF THE EMBODIMENT

Hereinafter, embodiments of the present disclosure will be described in detail with reference to the accompanying drawings. Advantages and characteristics of the present disclosure and a method of achieving the advantages and characteristics will be clear by referring to exemplary embodiments described below in detail together with the accompanying drawings. However, the present invention is not limited to exemplary embodiments disclosed herein but will be implemented in various different forms. The exemplary embodiments are provided by way of example only so that a person of ordinary skilled in the art can fully understand the disclosures of the present invention and the scope of the present invention. Therefore, the present invention will be defined only by the scope of the appended claims. Unless otherwise defined, all terms (including technical and scientific terms) used in the present specification may be used as the meaning which may be commonly understood by the person with ordinary skill in the art, to which the present invention belongs. It will be further understood that terms defined in commonly used dictionaries should not be interpreted in an idealized or excessive sense unless expressly and specifically defined.

Terms used in the present application are just used to describe a specific exemplary embodiment and do not intend to limit the present invention and a singular expression may include a plural expression as long as it is not apparently contextually different. In the present application, it should be understood that term “have” “may have”, “include” or “may include” indicates that a feature, a number, a step, an operation, a component, a part or a combination thereof described in the specification is present, but do not exclude a possibility of presence or addition of one or more other features, numbers, steps, operations, components, parts or combinations thereof, in advance. Terms including an ordinary number, such as first and second, are used for describing various constituent elements, but the constituent elements are not limited by the terms.

The above terms are used only to distinguish one component from the other component. For example, without departing from the scope of the present invention, a first component may be referred to as a second component, and similarly, a second component may be referred to as a first component. A term of and/or includes combination of a plurality of related elements or any one of the plurality of related elements.

In the present specification, in each step, numerical symbols (for example, a, b, and c) are used for the convenience of description, but do not explain the order of the steps so that unless the context apparently indicates a specific order, the order may be different from the order described in the specification. That is, the steps may be performed in the order as described or simultaneously, or an opposite order.

The term “˜unit” used in the specification refers to a software or hardware component such as a field programmable gate array (FPGA) or an ASIC and “˜unit” performs some functions. However, “˜unit” is not limited to the software or the hardware. “˜unit” may be configured to be in an addressable storage medium or may be configured to reproduce one or more processors. Accordingly, as an example, “˜unit” includes components such as software components, object oriented software components, class components, and task components, processes, functions, attributes, procedures, subroutines, segments of a program code, drivers, a firmware, a microcode, a circuit, data, database, and data structures. A function which is provided in the components and “˜units” may be combined with a smaller number of components and “˜units” or divided into additional components and “˜units”.

Hereinafter, various exemplary embodiments of a training operation variation compensating apparatus of a computation-in-memory based artificial neural network according to the present disclosure (hereinafter, referred to as a training operation variation compensating apparatus of an artificial neural network) will be described in more detail with reference to the accompanying drawings.

Exemplary embodiments disclosed in the present disclosure may be applied to various apparatuses and methods using an artificial neural network, such as a low-power embedded device, an edge device, a high performance artificial neural network acceleration system, an electronic device in which a processing-in-memory based artificial neural network acceleration system is mounted.

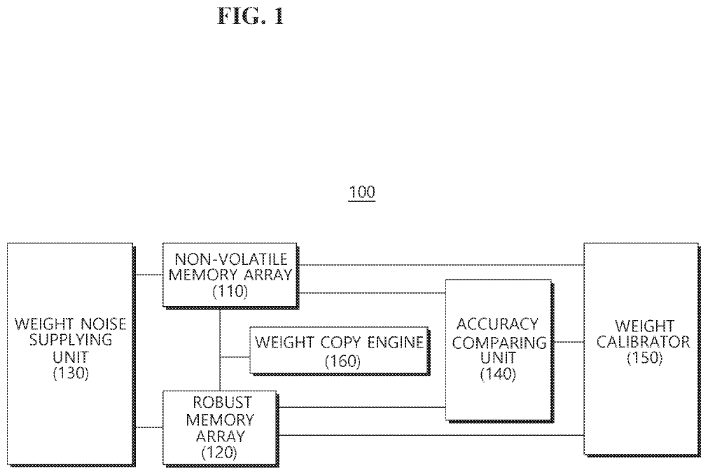

FIG. 1 is a view for explaining a configuration of a training operation variation compensating apparatus of an artificial neural network according to an exemplary embodiment of the present disclosure.

Referring to FIG. 1, the training operation variation compensating apparatus 100 of an artificial neural network includes a non-volatile memory array 110, a robust memory array 120, a weight noise supplying unit 130, an accuracy comparing unit 140, a weight calibrator 150, and a weight copy engine 160.

The non-volatile memory array 110 performs an operation for training an artificial neural network using a predetermined initial weight.

The robust memory array 120 performs an operation for training an artificial neural network, which is the same as the non-volatile memory array, using the initial weight.

The weight noise supplying unit 130 applies to any one of the non-volatile memory array 110 or the robust memory array 120 to perform the training operation using a weight obtained by reflecting a noise to the initial weight.

The accuracy comparing unit 140 compares a first accuracy for a value computed in the non-volatile memory array 110 and a second accuracy for a value computed in the robust memory array 120.

The weight calibrator 150 performs backward propagation based on a comparison result obtained in the accuracy comparing unit 140.

The weight copy engine 160 copies a weight from a memory array having a higher accuracy to a memory array having a lower accuracy based on the comparison result obtained from the accuracy comparing unit 140.

In the present disclosure, the accuracy is one of evaluation indicators used in machine learning and artificial neural networks and may refer to an indicator indicating how accurate the prediction of the model is, but is not limited thereto. Therefore, the accuracy may be an indicator indicating a reliability or a performance of a result value obtained from a training process of an artificial neural network.

The weight noise supplying unit 130 applies a nose to the robust memory array 120 at every predetermined first reference epoch (for example, any one of one to five times) to perform the training operation using a weight to which the noise is reflected.

The weight noise supplying unit 130 allows the robust memory array 120 to perform the training operation using the weight to which a noise is reflected, using a plurality of reference epochs within a predetermined first range (for example, a 1-1-th reference epoch, a 1-2-th reference epoch, and a 1-3-th reference epoch having different values).

The weight noise supplying unit 130 selects any one or two of the 1-1-th reference epoch, the 1-2-th reference epoch, and the 1-3-th reference epoch to allow the robust memory array 120 to perform the training operation using a weight to which the noise is reflected. However, the present disclosure is not limited thereto, so that wo or three of the 1-1-th reference epoch, the 1-2-th reference epoch, and the 1-3-th reference epoch are sequentially applied to allow the robust memory array 120 to perform the training operation using a weight to which the noise is reflected.

For example, when the 1-2-th reference epoch is larger than the 1-1-th reference epoch and the 1-3-th reference epoch is larger than the 1-2-th reference epoch, the weight noise supplying unit 130 operates in a first noise applying mode of repeatedly applying the noise to the robust memory array 120 as the 1-1-th reference epoch has elapsed and applying the noise to the robust memory array 120 as the 1-2-th reference epoch has elapsed, and applying the noise to the robust memory array 120 as the 1-1-th reference epoch has elapsed and applying the noise to the robust memory array 120 as the 1-2-th reference epoch has elapsed (the 1-1-th reference epoch and the 1-2-th reference epoch are repeatedly applied in this order).

The weight noise supplying unit 130 operates in a second noise applying mode of repeatedly applying the noise to the robust memory array 120 as the 1-1-th reference epoch has elapsed, applying the noise to the robust memory array 120 as the 1-2-th reference epoch has elapsed, and applying the noise to the robust memory array 120 as the 1-3-th reference epoch has elapsed, and applying the noise to the robust memory array 120 as the 1-1-th reference epoch has elapsed, applying the noise to the robust memory array 120 as the 1-2-th reference epoch has elapsed, and applying the noise to the robust memory array 120 as the 1-3-th reference epoch has elapsed (the 1-1-th reference epoch, the 1-2-th reference epoch, and the 1-3-th reference epoch are repeatedly applied in this order).

The weight noise supplying unit 130 operates in a third noise applying mode of repeatedly applying the noise to the robust memory array 120 as the 1-1-th reference epoch has elapsed, applying the noise to the robust memory array 120 as the 1-3-th reference epoch has elapsed, and applying the noise to the robust memory array 120 as the 1-2-th reference epoch has elapsed, and applying the noise to the robust memory array 120 as the 1-1-th reference epoch has elapsed, applying the noise to the robust memory array 120 as the 1-3-th reference epoch has elapsed, and applying the noise to the robust memory array 120 as the 1-2-th reference epoch has elapsed (the 1-1-th reference epoch, the 1-3-th reference epoch, and the 1-2-th reference epoch are repeatedly applied in this order).

The weight noise supplying unit 130 applies to the noise to the robust memory array 120 at every first reference epoch such that the noises are added to be accumulated, but is not limited thereto, but applies the noise after initializing to an initial weight at every predetermined first reference epoch.

The weight noise supplying unit 130 may apply a noise with a predetermined magnitude, but may repeatedly apply noises with different magnitudes. For example, the weight noise supplying unit 130 may apply noises with a first magnitude, a second magnitude, and a third magnitude.

When the second magnitude is larger than the first magnitude and the third magnitude is larger than the second magnitude, if the weight noise supplying unit 130 operates in a first noise applying mode, the weight noise supplying unit 130 operates in the 1-1-th noise applying mode of applying a noise with the first magnitude when the noise is applied to the robust memory array 120 as the 1-1-th reference epoch has elapsed and applying a noise with the second magnitude when the noise is applied to the robust memory array 120 as the 1-2-th reference epoch has elapsed.

When the weight noise supplying unit 130 operates in the first noise applying mode, the weight noise supplying unit 130 operates in the 1-2-th noise applying mode of applying a noise with the second magnitude when the noise is applied to the robust memory array 120 as the 1-1-th reference epoch has elapsed and applying a noise with the first magnitude when the noise is applied to the robust memory array 120 as the 1-2-th reference epoch has elapsed.

When the weight noise supplying unit 130 operates in the first noise applying mode, the weight noise supplying unit 130 may selectively operate in the 1-1-th noise applying mode or the 1-2-th noise applying mode or repeatedly operate in the 1-1-th noise applying mode and the 1-2-th noise applying mode.

When the weight noise supplying unit 130 operates in the second noise applying mode, the weight noise supplying unit 130 operates in a 2-1-th noise applying mode of applying a noise with the first magnitude when the noise is applied to the robust memory array 120 as the 1-1-th reference epoch has elapsed, applying a noise with the second magnitude when the noise is applied to the robust memory array 120 as the 1-2-th reference epoch has elapsed, and applying a noise with the third magnitude when the noise is applied to the robust memory array 120 as the 1-3-th reference epoch has elapsed.

When the weight noise supplying unit 130 operates in the second noise applying mode, the weight noise supplying unit 130 operates in a 2-2-th noise applying mode of applying a noise with the third magnitude when the noise is applied to the robust memory array 120 as the 1-1-th reference epoch has elapsed, applying a noise with the second magnitude when the noise is applied to the robust memory array 120 as the 1-2-th reference epoch has elapsed, and applying a noise with the first magnitude when the noise is applied to the robust memory array 120 as the 1-3-th reference epoch has elapsed.

When the weight noise supplying unit 130 operates in the second noise applying mode, the weight noise supplying unit 130 may selectively operate in the 2-1-th noise applying mode or the 2-2-th noise applying mode or repeatedly operate in the 2-1-th noise applying mode and the 2-2-th noise applying mode.

When the weight noise supplying unit 130 operates in the third noise applying mode, the weight noise supplying unit 130 operates in a 3-1-th noise applying mode of applying a noise with the first magnitude when the noise is applied to the robust memory array 120 as the 1-1-th reference epoch has elapsed, applying a noise with the third magnitude when the noise is applied to the robust memory array 120 as the 1-3-th reference epoch has elapsed, and applying a noise with the second magnitude when the noise is applied to the robust memory array 120 as the 1-2-th reference epoch has elapsed.

When the weight noise supplying unit 130 operates in the third noise applying mode, the weight noise supplying unit 130 operates in a 3-2-th noise applying mode of applying a noise with the third magnitude when the noise is applied to the robust memory array 120 as the 1-1-th reference epoch has elapsed, applying a noise with the first magnitude when the noise is applied to the robust memory array 120 as the 1-3-th reference epoch has elapsed, and applying a noise with the second magnitude when the noise is applied to the robust memory array 120 as the 1-2-th reference epoch has elapsed.

When the weight noise supplying unit 130 operates in the third noise applying mode, the weight noise supplying unit 130 may selectively operate in the 3-1-th noise applying mode or the 3-2-th noise applying mode or repeatedly operate in the 3-1-th noise applying mode and the 3-2-th noise applying mode.

Here, when a first accuracy is lower than a second accuracy, the weight copy engine 160 copies the weight from the robust memory array 120 to the non-volatile memory array 110 and the weight calibrator 150 performs backward propagation based on the training operation performed in the robust memory array 120.

Here, when the first accuracy is equal to or higher than the second accuracy, the weight copy engine 160 does not copy the weight and the weight calibrator 150 does not perform the backward propagation.

The accuracy comparing unit 140 compares the first accuracy and the second accuracy at every predetermined second reference epoch (for example one of three times to seven times). When the first accuracy is lower than the second accuracy at a predetermined third reference epoch or more (for example, one of five times or ten times), the weight calibrator 150 applies an calibration weight to allow the non-volatile memory array 110 to perform the training operation using the calibration weight.

The non-volatile memory array 110 performs the training operation by fixedly using the calibration weight as much as a predetermined fourth reference epoch (for example, one from 10 times to end of the trial).

The calibration weight may refer to a weight after an operation of modifying an initial weight during the training process of the artificial neural network. The calibration weight may be calculated by various variables, such as a learning rate or a momentum and an algorithm. The weight calibrator 150 allows the non-volatile memory array 110 to perform the training operation using the calibration weight by controlling the weight noise supplying unit 130 to allow the weight noise supplying unit 130 to supply the noise to the non-volatile memory array 110.

The first reference epoch, the second reference epoch, the third reference epoch, and the fourth reference epoch are determined by a data size, the complexity of data, an operation timing of the weight copy engine or the weight calibrator, and a characteristic of the non-volatile memory array or a characteristic of the robust memory array, are not necessarily limited thereto and may be determined by various different elements.

The non-volatile memory array 110 is based on at least one of a magnetoresistive random access memory (MRAM), a phase change memory, and a ferroelectric random access memory (FeRAM).

The robust memory array 120 may be based on a static random access memory (SRAM).

Not all the blocks illustrated in FIG. 1 are essential components and in another exemplary embodiments and some blocks connected to the training operation variant compensating apparatus 100 of an artificial neural network may be added, changed, or deleted.

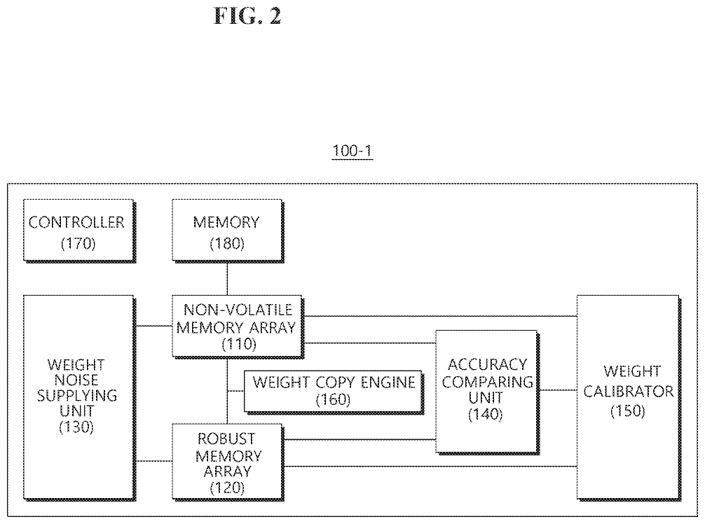

FIG. 2 is a view for explaining a configuration of a training operation variation compensating apparatus of an artificial neural network according to another exemplary embodiment of the present disclosure.

Referring to FIG. 2, a training operation variation compensating apparatus 100-1 of an artificial neural network according to another exemplary embodiment of the present disclosure may further include a controller 170 and a memory 180 in the training operation variation compensating apparatus 100 of an artificial neural network according to the exemplary embodiment of the present disclosure which has been described with reference to FIG. 1.

The controller 170 controls an operation of the training operation variation compensating apparatus 100-1 of an artificial neural network separately from the CPU or GPU located outside the training operation variation compensating apparatus 100-1 of an artificial neural network.

The controller 170 sets an initial weight used in the non-volatile memory array 110 and the robust memory array 120 in accordance with the user's designation.

The initial weight may be a value for an connection intensity or the importance of each neural before the artificial neural network begins the learning. The initial weight is optimized during the learning process of the neural network and is used to improve a prediction ability of the model.

The initial weight may be randomly set and then is calibrated and optimized by the learning data. However, it is not necessarily limited and the initial weight may be obtained by initializing a weight according to a depth of the neural network by a Xavier initializing or He initializing method.

The controller 170 may be applied with a start signal for operating the training operation variation compensating apparatus 100-1 of an artificial neural network from the outside of the training operation variation compensating apparatus 100-1 of an artificial neural network.

The controller 170 may transmit an input signal received from the training operation variation compensating apparatus 100-1 of an artificial neural network to the non-volatile memory array 110 and the robust memory array 120.

The controller 170 receives information about the above-described predetermined first reference epoch, second reference epoch, third reference epoch, and fourth reference epoch from the outside of the training operation variation compensating apparatus 100-1 of an artificial neural network and controls each component included in the training operation variation compensating apparatus 100-1 of an artificial neural network to operate in accordance with each epoch.

The memory 180 receives and stores a weight which is updated at the maximum repeated epoch of the training operation performed in the non-volatile memory 110 or the robust memory array 120 from the non-volatile memory 110 or the robust memory array 120.

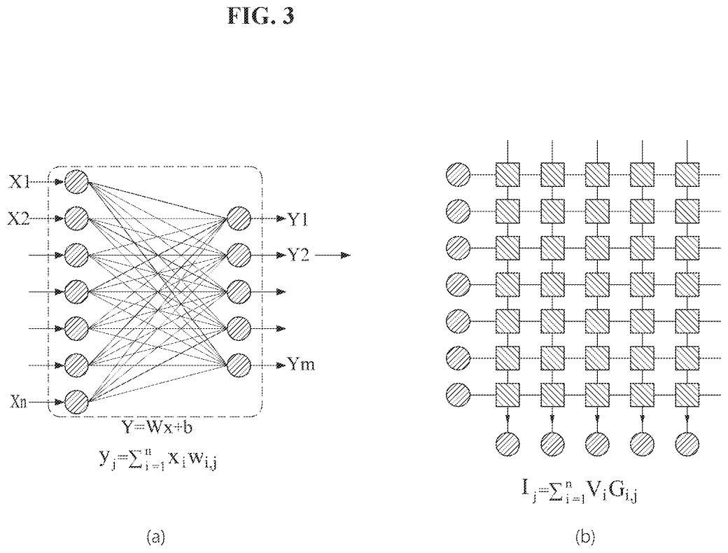

FIG. 3 is a view illustrating a computation-in-memory architecture based on a memory device of a training operation variation of an artificial neural network according to an exemplary embodiment of the present disclosure.

The present disclosure is based on a computation-in-memory (CIM) architecture based on a next-generation memory device.

When the artificial neural network training operation is performed based on the CIM architecture as illustrated in FIG. 3, a value stored in the memory may vary depending on a dynamic/static variation.

When the value stored in the memory varies, the training accuracy is affected and when a value with a large difference from a weight set by the training algorithm is actually stored, there is a problem in that the training is not possible.

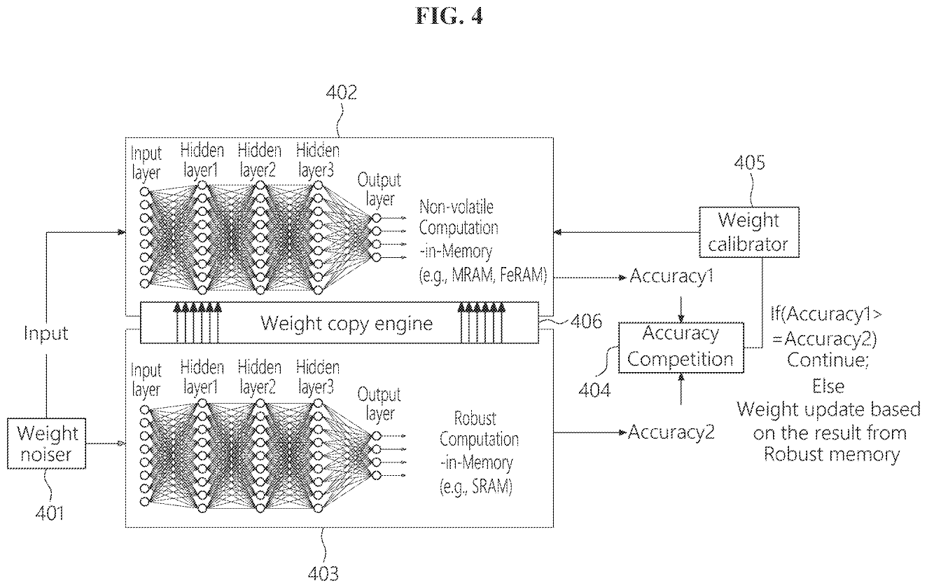

FIG. 4 is a view illustrating a process model used in training operation variation compensating apparatus and method of an artificial neural network according to an exemplary embodiment of the present disclosure.

Referring to FIG. 4, the present disclosure uses a structure which adds a circuit 401 to add an arbitrary noise to the stored value to allow a CIM array 402 to which the noise is not added and a CIM array 403 including a noise to simultaneously perform the training operation.

The CIM array 402 to which the noise is not added is a non-volatile memory array 110.

The CIM array 403 including a noise may be a robust memory array 120.

The weight noiser 401 allows the robust CIM to perform a convolutional operation with a weight which is higher or lower than a value stored according to a value set by the user. The weight noiser 401 may add an intentional variation to a weight.

The weight noise supplying unit 130 performs operations which are performed in the weight noiser 401.

The accuracy comparing unit 404 may determine which memory array is used to update the weight according to the accuracy result of the calculated values from the CIMs.

When the dynamic variation is identified using the robust CIM at every epoch, excessive energy overhead may be caused so that the dynamic variation is periodically checked at every specific epoch to reduce an unnecessary energy overhead.

When the accuracy of the non-volatile CIM 402 is lower than that of the robust CIM 403 more than a predetermined number of times, the weight calibrator 405 may statically change the weight of the non-volatile CIM 402 to a predetermined level. The weight calibrator 405 may be the weight calibrator 150.

The weight copy engine 406 copies the weight of the robust CIM 403 to the non-volatile CIM 402. The weight copy engine 406 may be the weight copy engine 160.

An accuracy result calculated in each memory array is regularly compared at every training epoch and backward propagation is performed based on a value output from the more accurate memory array.

As the model with the structure of FIG. 4 is applied, the artificial neural network training process and accuracy correction may be performed without intervention of the host processor (for example, CPU and GPU).

Two memory arrays 402 and 403 which may be applied to an artificial intelligence accelerator store the same weight in a start step of performing the training operation and operate as a pair.

The weight noise supplying unit (weight noiser) applies an arbitrary noise value to one memory array to change a value stored in the memory.

The accuracy comparing unit 140 compares results from two memory arrays to choose a result with a higher inference accuracy to be used for backward propagation.

The accuracy comparing unit 140 compares a first accuracy and a second accuracy based on previously stored reference data.

The weight copy engine 160 copies the weight from the robust CIM to the non-volatile CIM at a training epoch in which the accuracy of the robust CIM is better.

Next, the weight calibrator 150 performs the backward propagation.

When the accuracy of the non-volatile CIM is consistently lowered, the weight calibrator 150 determines that there is permanent variation (the cause may be cell aging or consistent change of an operating environment) and permanently add the weight modification to the non-volatile CIM.

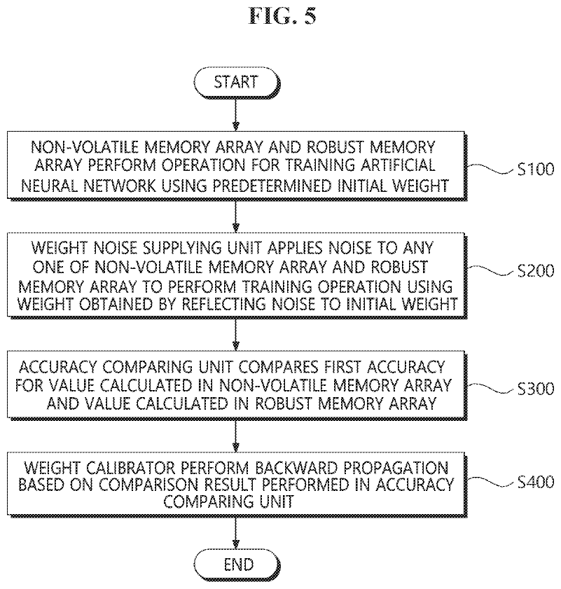

FIG. 5 is a flowchart for explaining a training operation variation compensating method of an artificial neural network according to an exemplary embodiment of the present disclosure.

In step S100, a non-volatile memory array and a robust memory array perform an operation for training an artificial neural network using a previously set initial weight.

In step S200, the weight noise supplying unit applies to any one of the non-volatile memory array or the robust memory array to perform the training operation using a weight obtained by reflecting a noise to the initial weight.

In step S300, the accuracy comparing unit compares a first accuracy for a value calculated in the non-volatile memory array and a second accuracy for a value calculated in the robust memory array.

In step S400, the weight calibrator performs the backward propagation based on a comparison result performed in the accuracy comparing unit.

Here, the method further includes a step of performing weight copy from a memory array having a higher accuracy to a memory array having a lower accuracy based on the comparison result obtained from the accuracy comparing unit, by the weight copy engine.

The step of performing weight copy by the weight copy engine may be performed after S300 or before S400.

In the step of performing a training operation using a weight obtained by reflecting a noise to the initial weight by applying a nose by the weight noiser, the noise is applied to the robust memory array at every predetermined first reference epoch to perform the training operation using a weight to which the noise is reflected.

Here, when the first accuracy is lower than the second accuracy, if the weight copy engine copies the weight, the weight is copied from the robust memory array to the non-volatile memory array and if the weight calibrator performs the backward propagation based on a comparison result performed in the accuracy comparing unit, the backward propagation is performed based on the training operation performed in the robust memory array.

Here, when the first accuracy is equal to or higher than the second accuracy, the weight copy engine does not copy the weight and the weight calibrator does not perform the backward propagation.

When the accuracy comparing unit compares the first accuracy and the second accuracy, the first accuracy and the second accuracy are compared at every predetermined second reference epoch and when the weight calibrator performs the backward propagation based on a comparison result performed in the accuracy comparing unit, if the first accuracy is lower than the second accuracy a predetermined third reference epoch or more, the calibration weight is applied to allow the non-volatile memory array to perform the training operation using the calibration weight.

When the non-volatile memory array performs the operation for training the artificial neural network using a predetermined initial weight, the non-volatile memory array 110 is based on at least one of a magnetoresistive random access memory (MRAM), a phase change memory, and a ferroelectric random access memory (FeRAM).

When the robust memory array performs an operation for training the artificial neural network like the non-volatile memory array, the robust memory array is based on a static random access memory (SRAM).

In FIG. 5, the respective processes are sequentially performed, but this is merely illustrative and those skilled in the art may apply various modifications and changes by changing the order illustrated in FIG. 5 or performing one or more processes in parallel or adding another process without departing from the essential gist of the exemplary embodiment of the present disclosure.

The application also provides a computer storage medium. In the computer storage medium, a program instruction is stored and when the program instruction is executed by a processor, a control method of the above-described method for compensating a training operation variation of the artificial neural network is implemented.

The computer storage medium according to the exemplary embodiment of the present disclosure may be a U disk, a SD card, a PD optical drive, a mobile hard disk, a high-capacity floppy drive, a flash memory, a multimedia memory card, or a server, but is not necessarily limited thereto.

According to the present disclosure, a variation compensating apparatus and method of a computation-in-memory operation based artificial neural network system are disclosed.

According to the present disclosure, a technology for an accuracy correcting apparatus and an operating method in consideration of a dynamic/static variation of a memory without intervention of the CPU/GPU in the artificial neural network accelerator system based on the computation-in-memory is disclosed.

As the data size and an amount of parameters become increasingly larger, the amount of memory and computational complexity required for training are increasing significantly.

Even though processing-in-memory technology is being researched as a technology that can maximize computing performance/energy efficiency while reducing memory bottlenecks, there are fundamental limitations in memory devices.

When the accuracy correcting apparatus based on computation-in-memory according to the present disclosure which is proposed in this situation is utilized, the processing-in-memory may be upgraded to a technology which is used for a longer period in various environments.

Even though it has been described above that all components of the exemplary embodiment of the present invention are combined as one component or operate to be combined, the present invention is not limited to the exemplary embodiment. In other words, one or more components may be selectively combined to be operated within a scope of the present invention. Further, all components may be implemented as one independent hardware but a part or all of the components are selectively combined to be implemented as a computer program which includes a program module which performs a part or all functions combined in one or plural hardwares. Further, such a computer program may be stored in a computer readable media such as a USB memory, a CD disk, or a flash memory to be read and executed by a computer to implement the exemplary embodiment of the present invention. The recording media of the computer program may include a magnetic recording medium or an optical recording medium.

The above description illustrates a technical spirit of the present invention as an example and various changes, modifications, and substitutions become apparent to those skilled in the art within a scope of an essential characteristic of the present invention. Therefore, as is evident from the foregoing description, the exemplary embodiments and accompanying drawings disclosed in the present invention do not limit the technical spirit of the present invention and the scope of the technical spirit is not limited by the exemplary embodiments and accompanying drawings. The protection scope of the present invention should be interpreted based on the following appended claims and it should be appreciated that all technical spirits included within a range equivalent thereto are included in the scope of the present invention.

What is claimed is:

1. A training operation variation compensating apparatus of an artificial neural network, comprising:
a non-volatile memory array which performs an operation for training the artificial neural network using a predetermined initial weight;
a robust memory array which performs an operation for training an artificial neural network which is the same as the non-volatile memory array using the initial weight;
a weight noise supplying which applies a noise to any one of the non-volatile memory array or the robust memory array to perform the training operation using a weight obtained by reflecting the noise to the initial weight;
an accuracy comparing unit which compares a first accuracy for a value calculated in the non-volatile memory array and a second accuracy for a value calculated in the robust memory array; and
a weight calibrator which performs backward propagation based on the comparison result performed in the accuracy comparing unit.

2. The training operation variation compensating apparatus of an artificial neural network according to claim 1, further comprising:
a weight copy engine which performs weight copy from a memory array having a higher accuracy to a memory array having a lower accuracy based on the comparison result obtained from the accuracy comparing unit, by the weight copying unit.

3. The training operation variation compensating apparatus of an artificial neural network according to claim 2, wherein the weight noise supplying unit applies a noise to the robust memory array at every predetermined first epoch to perform the training operation using the weight in which the noise is reflected.

4. The training operation variation compensating apparatus of an artificial neural network according to claim 3, wherein when the first accuracy is lower than the second accuracy, the weight copy engine performs the weight copy from the robust memory array to the non-volatile memory array and the weight calibrator performs the backward propagation based on a training operation performed in the robust memory array.

5. The training operation variation compensating apparatus of an artificial neural network according to claim 3, wherein when the first accuracy is equal to or higher than the second accuracy, the weight copy engine does not copy the weight and the weight calibrator does not performs the backward propagation.

6. The training operation variation compensating apparatus of an artificial neural network according to claim 1, wherein the accuracy comparing unit compares the first accuracy and the second accuracy at every predetermined second reference epoch, and
when the first accuracy is lower than the second accuracy a predetermined reference epoch or more, the weight calibrator applies an calibration weight to allow the non-volatile memory array to perform the training operation using the calibration weight.

7. The training operation variation compensating apparatus of an artificial neural network according to claim 1, wherein the non-volatile memory array is based on at least one of a magnetoresistive random access memory (MRAM), a phase change memory, and a ferroelectric random access memory (FeRAM).

8. The training operation variation compensating apparatus of an artificial neural network according to claim 1, wherein the robust memory array is based on a static random access memory (SRAM).

9. A training operation variation compensating method of an artificial neural network performed in a training operation variation compensating apparatus of an artificial neural network including a non-volatile memory array, a robust memory array, a weight noise supplying unit, an accuracy comparing unit, a weight copy engine, and a weight calibrator, comprising:
a step of allowing the non-volatile memory array and the robust memory array to perform an operation for training an artificial neural network using a predetermined initial weight;
a step of allowing weight noise supplying to apply a noise to any one of the non-volatile memory array or the robust memory array to perform the training operation using a weight obtained by reflecting the noise to the initial weight;
a step of allowing the accuracy comparing unit to compare a first accuracy for a value calculated in the non-volatile memory array and a second accuracy for a value calculated in the robust memory array; and
a step of allowing the weight calibrator to perform backward propagation based on a comparison result performed in the accuracy comparing unit.

10. The training operation variation compensating method of an artificial neural network according to claim 9, further comprising:
a step of allowing a weight copy engine to perform weight copy from a memory array having a higher accuracy to a memory array having a lower accuracy based on the comparison result obtained from the accuracy comparing unit, by the weight copying unit.

11. The training operation variation compensating method of an artificial neural network according to claim 10, wherein in the step of allowing weight noise supplying to apply a noise, a noise is applied to the robust memory array at every predetermined first epoch to perform the training operation using the weight in which the noise is reflected.

12. The training operation variation compensating method of an artificial neural network according to claim 11, wherein when the first accuracy is lower than the second accuracy, if the weight copy engine performs the weight copy, the weight is copied from the robust memory array to the non-volatile memory and
when the weight calibrator performs the backward propagation based on the comparison result performed in the accuracy comparing unit, the weight calibrator performs the backward propagation based on a training operation performed in the robust memory array, and
when the first accuracy is equal to or higher than the second accuracy, the weight copy engine does not copy the weight and the weight calibrator does not perform the backward propagation.

13. The training operation variation compensating method of an artificial neural network according to claim 9, wherein when the accuracy comparing unit compares the first accuracy and the second accuracy, the first accuracy and the second accuracy are compared at every predetermined second reference epoch and
when the weight calibrator performs the backward propagation based on the comparison result performed in the accuracy comparing unit, if the first accuracy is lower than the second accuracy a predetermined reference epoch or more, the weight calibrator applies an calibration weight to allow the non-volatile memory array to perform the training operation using the calibration weight.

14. The training operation variation compensating method of an artificial neural network according to claim 9, wherein when the non-volatile memory array performs the operation for training the artificial neural network using a predetermined initial weight, the non-volatile memory array is based on at least one of a magnetoresistive random access memory (MRAM), a phase change memory, and a ferroelectric random access memory (FeRAM) and
when the robust memory array performs an operation for training the artificial neural network like the non-volatile memory array, the robust memory array is based on a static random access memory (SRAM).

15. A computer program stored in a computer readable recording medium to allow a computer to execute the training operation variation compensating method of an artificial neural network according to claim 9.
